(19) United States
(12) Patent Application Publication
(10) Pub. No.: US 2011/0276426 A1
(43) Pub. Date: Nov. 10, 2011

(54) Methods and systems for facilitating aircraft parts manufacturing

(75) Inventor: Humberto Brache, Santa Clarita, CA (US)

(73) Assignee: Loop Aerospace Corporation, Santa Clarita, CA (US)

(21) Appl. No.: 13/068,210

(22) Filed: May 4, 2011

Related U.S. Application Data
(60) Provisional application No. 61/343,962, filed on May 5, 2010.

(51) Int. Cl. G06Q 30/00

(52) U.S. Cl. 705/26.4

(57) ABSTRACT

A computer-implemented method for facilitating manufacturing of aircraft parts, the method comprising: gathering from a user, via a first computer, the user's aircraft information; gathering, via the first computer, a specification for an aircraft part; soliciting, via a second computer, at least one quotation from a supplier to supply the aircraft part; and ordering the aircraft part based on the quotation from the supplier.

### CROSS REFERENCES TO RELATED APPLICATIONS

This application claims the benefit of U.S. provisional patent application Ser. No. 61/343,962 filed May 5, 2010.

### STATEMENT REGARDING FEDERALLY SPONSORED RESEARCH OR DEVELOPMENT

None

### TECHNICAL FIELD

The present application generally relates to information processing and, in one specific example, to methods and systems for facilitating aircraft parts manufacturing.

### BACKGROUND

The manufacturing of aftermarket, replacement, or modified aircraft parts, or aircraft parts that are not from an Original Equipment Manufacturer (non-OEM) for use with aircrafts in the United States is highly regulated by the United States Federal Aviation Administration or FAA. In general, aftermarket, replacement, modified, or non-OEM aircraft parts that are for sale have to go through an FAA regulatory process called Parts Manufacturer Approval or PMA. The PMA process ensures that the proposed part design meets the FAA safety requirements, and the manufacturer has an FAA-approved quality assurance system that verifies that each part is manufactured to meet the FAA-approved design. The PMA process can take about 11-24 months.

In situations there is no PMA-approved or OEM replacement part, aircraft owners may find it impractical to wait for a manufacturer to go through a successful PMA submission. The United States federal aviation regulations allow owners and operators to produce their own parts for maintaining or altering their own aircrafts so long as these parts are not for resale and conform with FAA-approved data. The owners or operators do not have to literally make their own parts. They can be considered to have produced their own parts when they have participated in controlling the design, manufacturing, and tracking the quality of the parts being produced. Participation in the design or manufacture of the parts or in tracking the quality of the parts can be in the form of providing design or performance data, materials, fabrication processes or assembly methods, quality control procedures or supervising the manufacture of the parts. It is desirable to have methods and systems that aid owners or operators participate in the design or manufacture of aircraft parts. It is desirable to have methods and systems that aid owners or operators produce their own aftermarket, replacement, modified, or non-OEM aircraft parts.

### BRIEF SUMMARY

The present invention includes a computer-implemented method for facilitating manufacturing of aircraft parts, the method comprising: gathering from a user, via a first computer, the user's aircraft information; gathering, via the first computer, a specification for an aircraft part; soliciting, via a second computer, at least one quotation from a supplier to supply the aircraft part; and ordering the aircraft part based on the quotation from the supplier.

The present invention also includes A computer-implemented method for facilitating manufacturing of aircraft parts, the method comprising: gathering via a computer manufacturing specification for at least one aircraft part from an aircraft part user; composing via the computer a request for a quotation based on the gathered specification; transmitting via a second computer the request for a quotation to a plurality of aircraft parts suppliers; gathering from the plurality of aircraft parts suppliers a plurality of quotations to manufacture the aircraft part; and transmitting the plurality of quotations to the aircraft part user.

The present invention further includes a system for facilitating manufacturing of aircraft aftermarket parts, the system comprising: an aircraft part user computer, the aircraft part user computer comprising an input device, the input device being configured to allow a user to enter an aircraft part specification; a server computer connected to the aircraft part user computer, the server computer comprising: a request for quotation generator configured to generate a request for quotation based on the aircraft part specification entered by the user; and a database of a plurality of aircraft part suppliers; and a supplier connector computer connected to the aircraft part user computer and the server computer, the supplier connector computer configured to utilize the database and transmit the request for a quotation to the plurality of aircraft part suppliers, the supplier connector computer further configured to receive quotations from the plurality of aircraft part suppliers and transmit the quotations to the aircraft part user computer.

The above description sets forth, rather broadly, a summary of embodiments of the present invention so that the detailed description that follows may be better understood and contributions of the present invention to the art may be better appreciated. Some of the embodiments of the present invention may not include all of the features or characteristics listed in the above summary. There may be, of course, other features of the invention that will be described below and may form the subject matter of claims. In this respect, before explaining at least one embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways.

### BRIEF DESCRIPTION OF THE SEVERAL VIEWS OF THE DRAWINGS

FIG. 1 is substantially a flowchart showing an embodiment of a registration process of the present invention.

FIG. 2 is substantially a screenshot of a registration page embodiment of the present invention.

FIG. 3 is substantially a screenshot of an administrator dashboard embodiment of the present invention.

FIG. 4 is substantially a screenshot of a user dashboard embodiment of the present invention.

FIG. 5 is substantially a flowchart showing an embodiment of a request for quotation (hereinafter “RFQ”) submission process of the present invention.

FIG. 6 is substantially a screenshot of an embodiment of an RFQ submission form of the present invention.

FIG. 7 is substantially a screenshot of an RFQ prepared using the form from FIG. 6.

FIG. 8 is substantially a flowchart showing an embodiment of the supplier bidding and part ordering process of the present invention.

FIG. 9 is substantially a screen shot of an embodiment of a supplier bidding form of the present invention.

FIG. 10 is substantially a screen shot of an embodiment of a supplier data update form of the present invention.

FIG. 11 is substantially a schematic illustration showing the systems architecture and communications link between the computers in an embodiment of the present invention.

FIG. 12 is substantially a schematic illustration showing the detailed structures of the computers of FIG. 11.

### DETAILED DESCRIPTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention. When discussing the manner of operation and use of certain embodiments of the present invention or any of the flowcharts included in the present application, it is to be understood that the order in which the steps are presented is not limited to any particular order and does not necessarily imply that they have to be performed in the order presented. It will be understood by those of ordinary skill in the art that the order of these steps can be rearranged and performed in any suitable manner. It will further be understood by those of ordinary skill in the art that some steps may be omitted or added and still fall within the spirit of the invention.

Also, it is to be understood that the phraseology and terminology employed herein are for the purpose of description and should not be regarded as limiting. As used herein, the term “service provider” is used to refer to person or facilities authorized by the FAA to manufacture aircraft parts for sale. For instance, they can be an FAA-approved repair station, an FAA-designated consultant (also known as Designated Engineering Representative (“DER”) or Designated Airworthiness Representative (“DAR), authorized inspectors, Airframe and Powerplant technicians or aircraft mechanics, Original Equipment Manufacturers, entities holding FAA production approvals, such as PMA, Technical Standard Order (“TSO”), or Supplemental Type Certificate (“STC”), Distributors. The term “supplier” is used to refer to an entity involved in the supply chain or in providing a product to a customer and may include, without limitation, manufacturers, distributors, wholesalers, and retailers. The term “service provider” may include a “supplier” and thus may be used interchangeably with the term “supplier.”

The present invention includes various systems and methods for facilitating the manufacturing of aircraft parts either for sale (in which case PMA approval would be required) or for the own use of the aircraft owner or operator (no PMA approval required). The various preferred steps involved in the methods for facilitating the manufacturing of aircraft parts generally include registration and log-in, RFQ submission by the user, RFQ transmission to the suppliers, transmission of suppliers' responses to the RFQ, quote selection by the user, parts ordering, and order monitoring.

Registration and Log-In

In the preferred embodiment, a user may be required to go through a registration process wherein the user may be asked provide a provider of the present invention with the user's relevant identification information before manufacturing quotes can be requested and obtained or before business transactions can be pursued through the methods and systems of the present invention. At least one goal of the registration process is to assist the provider in complying with the FAA regulations. For instance, the information the provider may gather through the registration process may allow the provider to determine whether the part being requested requires PMA approval.

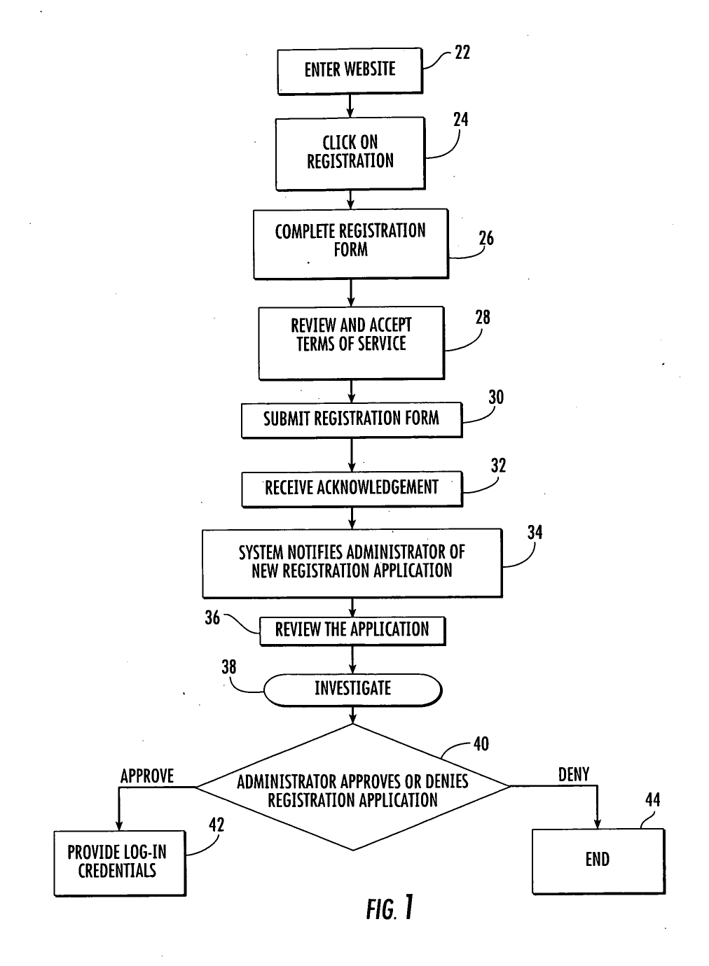

Referring now to FIG. 1, to register, a new user preferably uses a computer and enters a website of a provider of the present invention (step 22). The user may click on the registration icon on the website's homepage (step 24). A registration form is preferably presented to the user to complete (step 26). The user may also be presented with the terms of service to review and accept (step 28). After the user accepts the terms of service, the user may submit the completed registration form (step 30). The user preferably receives a confirmation of the submission (step 32). Next, an administrator is preferably of notified of the new registration application (step 34). The administrator may be notified such as by email about the new registration application received by the system. The administrator may then review the application (step 36), and may conduct additional investigation (step 38) to decide whether to approve or deny the application. The investigation may be as simple as contacting the applicant to obtain additional information, or it may involve complicated background checks. If the administrator approves the application, the administrator preferably provides the applicant with credentials, such as a username and password, needed to log into the system (step 42). The administrator may also deny the application and refuse to grant log in credentials to the applicant (step 44).

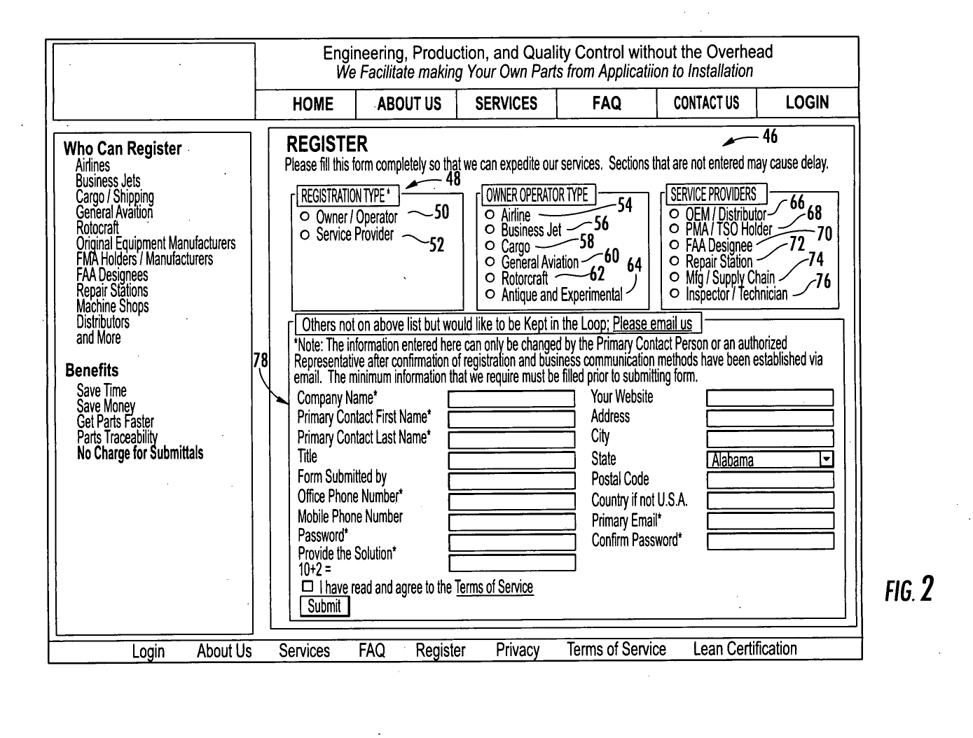

Referring now to FIG. 2, the registration form 46 preferably includes a registration type selection 48. The user may choose whether to register as an aircraft owner or operator 50 or as a service provider 52. If the user chooses to register as an aircraft owner or operator, the registration form 46 preferably asks the user whether the user owns or operates an airline 54, a business jet 56, a cargo plane 58, a general aviation plane 60, a rotorcraft 62, or an antique or experimental plane 64. If the user chooses to register as a service provider, the registration form 46 preferably asks the user to specify whether the user is an Original Equipment Manufacturer or an OEM part distributor 66, a holder of FAA production approval, such as a PMA or a TSO Holder 68, an FAA-designated consultant or FAA designee 70, a repair station 72, a part supplier 74, or an inspector or technician 76. The registration form 46 preferably also includes a biographical section 78 for the registrant to provide biographical or identification information, such as company name, contact name, address, phone numbers, email address, and the like. It can be realized that certain embodiments of the present invention provide a way of screening users and determining the FAA-compliant manufacturing process to adopt for each user's circumstances. For instance, if the users are aircraft owners or operators, the system can to cause them to participate in the production process, such as by obtaining aircraft part specifications from them, before allowing them to order parts from suppliers.

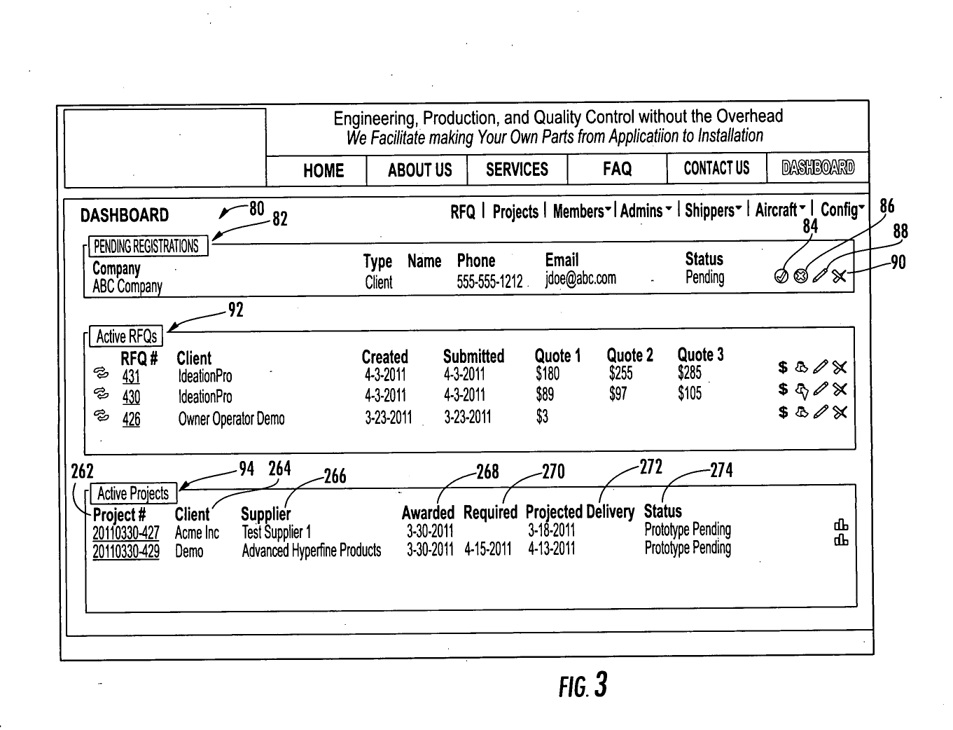

The administrator may be provided with its own special access webpage to conduct the registration process. For instance, after the administrator is notified of the new application via email, the administrator may log into an administration webpage. The administrator may then enter the appropriate username and password to log-in. Referring now to FIG. 3, an administrator dashboard 80 showing pending registrations 82 or registration requests that need to be processed by the administrator is preferably shown to the administrator. Various action icons 84, 86, 88, and 90 may be available to the administrator. The administrator may click on an edit icon 88 to make desired changes to the form. The administrator may click on an approve icon 84 to approve the registration application or deny icon 86 to deny the registration application. A delete icon 90 may also be provided to delete a registration application. The administrator's decision to approve or deny the registration application may then be communicated to the user preferably by an email message. The administrator dashboard 80 may include a list of requests for quotes 92 from clients awaiting the review of the administrator before they can be sent to the suppliers, as further explained below. The administrator dashboard 80 may also include a list of active projects 94 or manufacturing projects facilitated by the systems and methods of the present invention, also as further explained below.

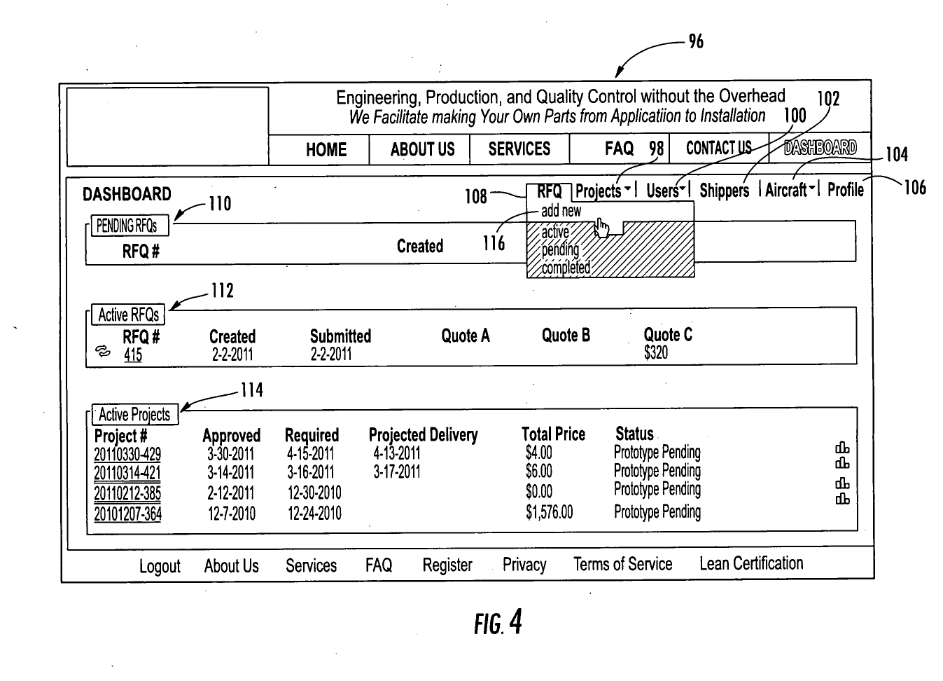

Once the user is registered, the user preferably is given log-in credentials, such as a username and password. The user may use these credentials to fully utilize the systems and methods of the present invention. The user may go to the website of the provider of the systems and methods of the present invention. The user may click on the login icon and enter the username and password. The system may verify the login information. If the username or the password is not correct, access is preferably denied. When the correct username and password is entered, the user is preferably directed to a webpage that shows a user dashboard, such as the user dashboard 96 shown in FIG. 4.

The user dashboard 96 preferably allows the user to view projects 98 or parts currently being manufactured or previously manufactured using the systems and methods of the present invention. The user dashboard 96 preferably also allows the user to view or edit: other users 100 authorized by the user, shipping or logistic companies of the user 102, information about the user's aircraft(s) 104, user's profile 106, or user's RFQs 108 to produce an aircraft part.

The user dashboard shown in FIG. 4 shows a detailed listing of the user's RFQs. The user's RFQs include pending RFQs 110, active RFQs 114, and active projects 114. Pending RFQs 110 may be incomplete or in-progress RFQs to be completed by the user. Active RFQs 112 may be those RFQs that the user has previously submitted to the administrator. The active RFQs 112 may be shown to include details about when the each RFQ was created, when the RFQ was submitted to the administrator, and the quotations received from various suppliers. For instance, the RFQ number 415 is shown to have been created on Feb. 2, 2011 and submitted to Administrator on Feb. 2, 2011. RFQ number 415 has received only one quote so far, which is for $320. Active projects 114 may be those resulting from RFQs that have been submitted to the administrator by the user, responded to by parts suppliers, and pursued by the user using the systems and methods of the present invention. The active projects 114 may be shown to include details about when the project was approved, when the project will be required, projected delivery date, total price, and project status. For instance, a quote for project number 20101207-364 was accepted by the user on Dec. 7, 2010. The user required the part to be produced by Dec. 24, 2010. The total price for the part was $1,576, and the current status of the project is that the prototype for the part is still pending.

RFQ Submission

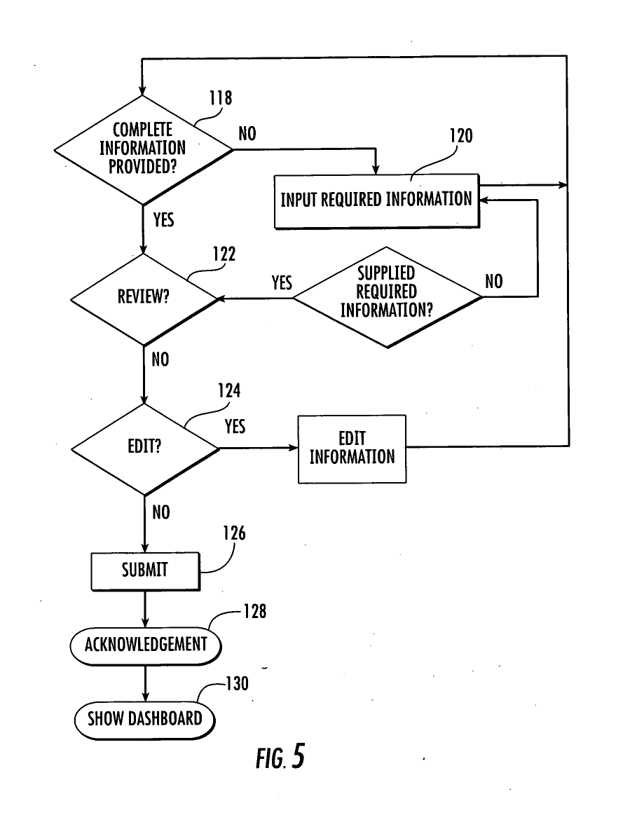

The user may use the systems and methods of the present invention to efficiently obtain manufacturing quotes or estimates from a plurality of parts suppliers. To submit a new request for quotation, the user preferably clicks on the “add new” RFQ icon 116. Referring now to FIG. 5, after the user clicks on the “add new” RFQ icon 116, the system preferably determines whether the user has provided complete information for the RFQ (step 118). If the information provided is not complete, the user is preferably required to input the requisite information (step 120). If complete information has been provided, the system may ask the user to review the RFQ (step 122). For instance, the user may also review the drawings to see if the drawings are acceptable. The system may then ask the user to make any necessary edits before submitting the RFQ (step 124). The user may then submit the RFQ to the administrator, if the user feels that the RFQ information is acceptable (step 126). After the RFQ is submitted, the user may receive an acknowledgement of RFQ submission (step 128) and may be directed to the user dashboard (step 130).

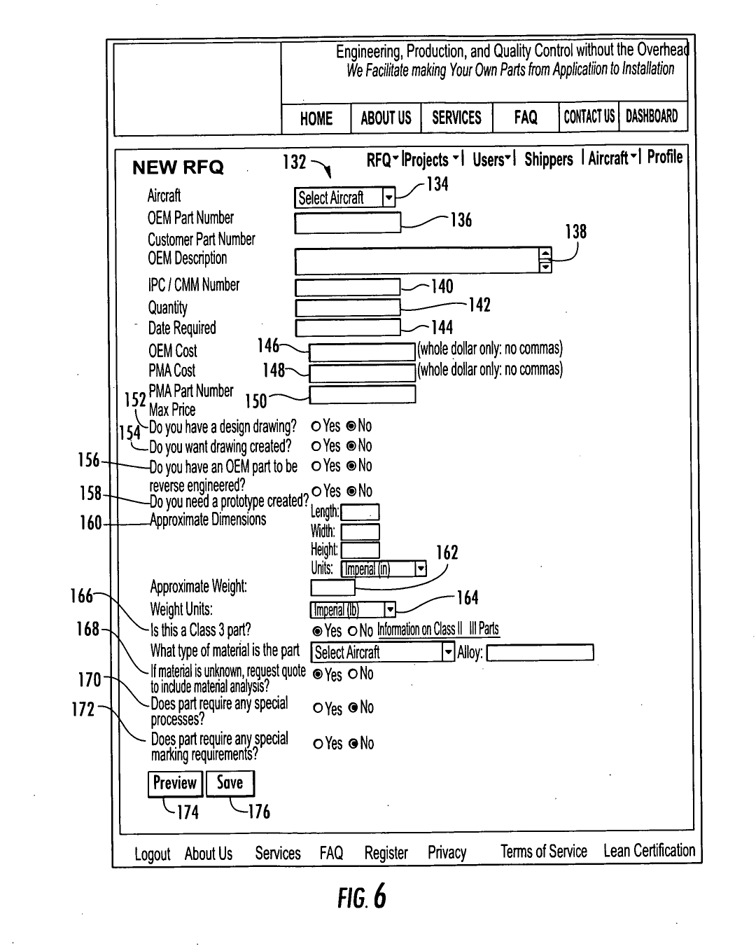

FIG. 6 provides an image of an embodiment of a webpage with an RFQ form 132 for the user to complete when submitting a new RFQ. The RFQ form 132 preferably asks the user for the name of the aircraft 134 for which the user needs a part. The system may have stored various aircraft names, or may use one or more aircrafts the user has listed in his profile. Next, the RFQ form preferably requests the user for a part number of an equivalent OEM part 136, if available. The RFQ form may also ask the user for- any part number the user may have or an OEM description 138, number from Illustrated Parts Catalog (“IPC”) or Component Maintenance Manual (“CMM”) 140, quantity 142, date the user requires the production to be finished 144, cost of an OEM equivalent 146, cost of an equivalent PMA approved part 148, and the user's maximum price 150.

The RFQ form may also solicit a yes or no answer for the following questions: whether the user has a design drawing 152, whether the user wants a drawing created 154, whether the user wants to have an OEM part reversed engineered 156, whether the user wants a prototype created 158, the approximate dimensions of the part 160, the approximate weight of the part 162, the unit for the weight measure used 164, and whether this part is a class 3 part 166. Class 3 parts are defined as parts considered non-critical to flight such that the failure of the part would not affect the continued safe flight. If the user has design drawings, the user is preferably asked to upload the design drawings into the system. The RFQ form may further ask the user what kind of material is the part. The system may previously store a list of materials, which the system may display for the users to select, such as aluminum, cast aluminum, extruded aluminum, sheet aluminum, aluminum tubing, bronze alloy, copper, nylon, plastic, specialty alloy, stainless steel, steel, steel alloy, or unknown material. The RFQ form further asks whether the user wants to request a quote to include material analysis if the material is unknown 168.

Next, the RFQ form may ask the user what kind of manufacturing process is involved in producing the part, if known (not shown in FIG. 6), or if the part requires any special processes 170. The system may previously store a list of processes, which the system may display for the user to select, such as 3D scan, 3D scan using a CAD model, 3D scan using a prototype, alodine, anodize, black anodize, bond, chemfilm, design drawing, design drawing (PMA), heat treat, paint, passivate, bronze plating, chrome plating, plating based on the user's specification, gold plating, nickel plating, or welding. It is noted that the administrator may be able to add or change this list on an administrator page of the website. The user may also request the administrator to add a process to the list.

The RFQ form may also ask the user what kind of marking the user requires (not shown in FIG. 6), or whether the user has any special marking requirements 172. The system may previously store a list of marking manners, such as bagging and tagging, vibro engraving, CNC engraving, laser engraving, labeling based on owner or operator's specification, standard labeling, markings on administrator's recommendations, name plate, pad print, rubber stamp, silk screen, or vibra peen. The administrator may be able to add or change this list on an administrator page of the website. The user may also request the administrator to add a marking procedure to the list. The webpage showing the RFQ form 132 preferably allows the user to preview the information supplied 174 or save the information supplied 176.

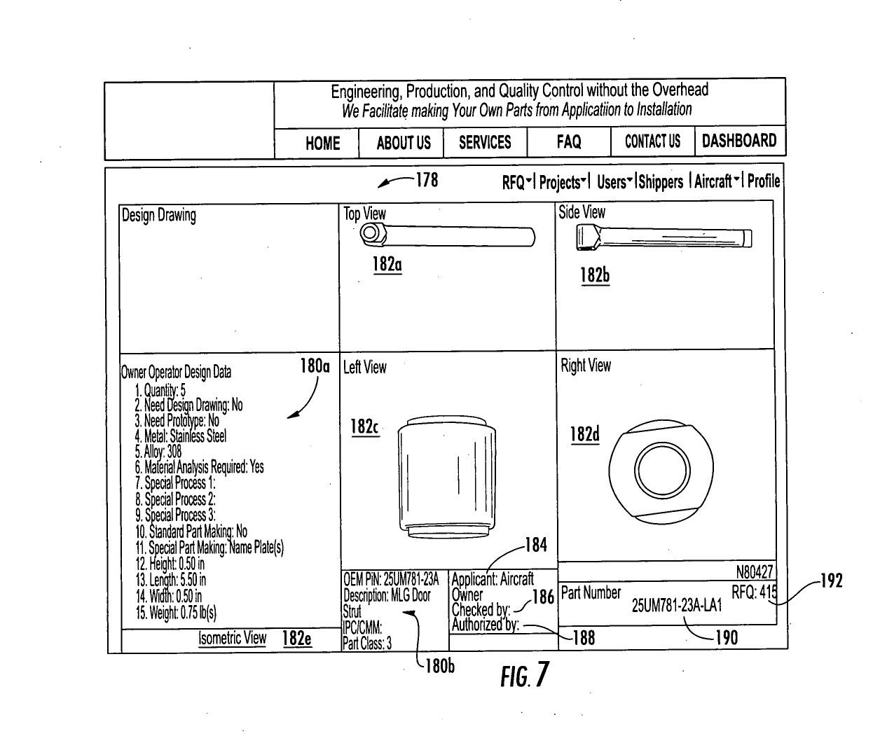

Referring now to FIG. 7, an embodiment of a preview image 178 of an RFQ is shown wherein the data provided by the user on the RFQ form 132 is summarized on data sections 180a and 180b. The previous image 178 preferably includes various views 182a-e of the part the user needs to be produced and that the user uploaded when completing the RFQ form 132. The system through the administrator preferably adds the RFQ requestor name 184, the person who checked the RFQ 186, and the person who authorized the RFQ to be submitted to suppliers 188. The administrator may further provide a custom part number 190 and an RFQ number 192.

Supplier Bidding and Parts Ordering

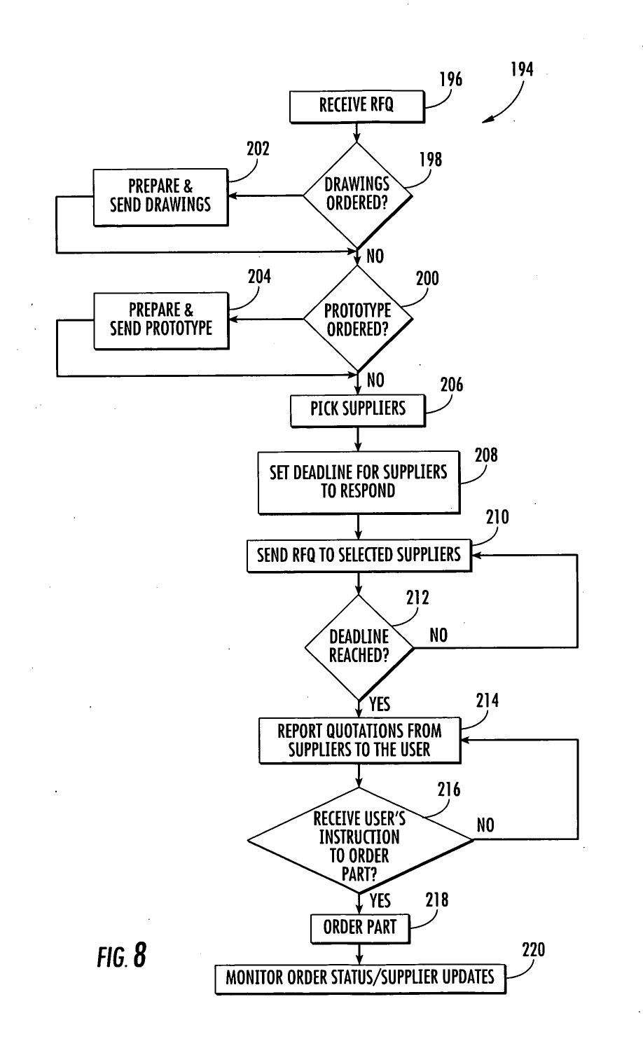

With reference now to flowchart 194 in FIG. 8, once the administrator receives the processed RFQs from the users (196), the administrator may check whether the users have requested for part drawings (step 198) or for prototypes (step 200). If the users have requested for drawings or prototypes, the administrator preferably fulfills these requests first. Thus, the administrator prepares the part drawings (step 202) or the prototypes (step 204), then sends them to their respective users. Part drawings or the prototypes may serve as valuable guides for the suppliers to be able to provide accurate quotes so it is preferred that they be in place before the RFQs are submitted to the suppliers.

Next, the administrator preferably picks the suppliers from its supplier database to send the RFQ (step 206). The administrator may rely on the data the users provided on their RFQs and compare them with the suppliers' backgrounds or expertise. The database may have predefined categories of suppliers for the administrator to use when selecting the suppliers. For instance, the suppliers may be classified based on their location, volume requirements, materials specialty or manufacturing specialty. In other embodiments, the administrator may rely on its knowledge and experience when selecting suppliers. The administrator may then set the deadline for the suppliers to respond to the RFQs (step 208). The deadline can be based on the users' requirements or on the administrator's discretion. The administrator preferably sends the RFQs to the selected suppliers (step 210) and waits till the deadline (step 212). When the deadline is reached, the administrator preferably reports the quotations from the suppliers to their respective users (step 214). The users may ask questions about the quotations, proceed with ordering the parts, or negotiate. If the administrator receives a user's instruction to order a part (step 216), the administrator preferably orders the part (step 218) and monitors the status of the order (step 220). After the user receives the part ordered, the user may enter the acceptance of the parts. The service computer may then provide a release or certification form to the user, which preferably closes the project number assigned and stores information for future access to the user or the FAA, or for other audit purposes. It is noted that, in the preferred embodiment, communications between the users and the suppliers preferably go through the administrator, to allow for efficient communications, to minimize any conflicts between the users and suppliers, and to allow for efficient resolution of any dispute between the users and suppliers.

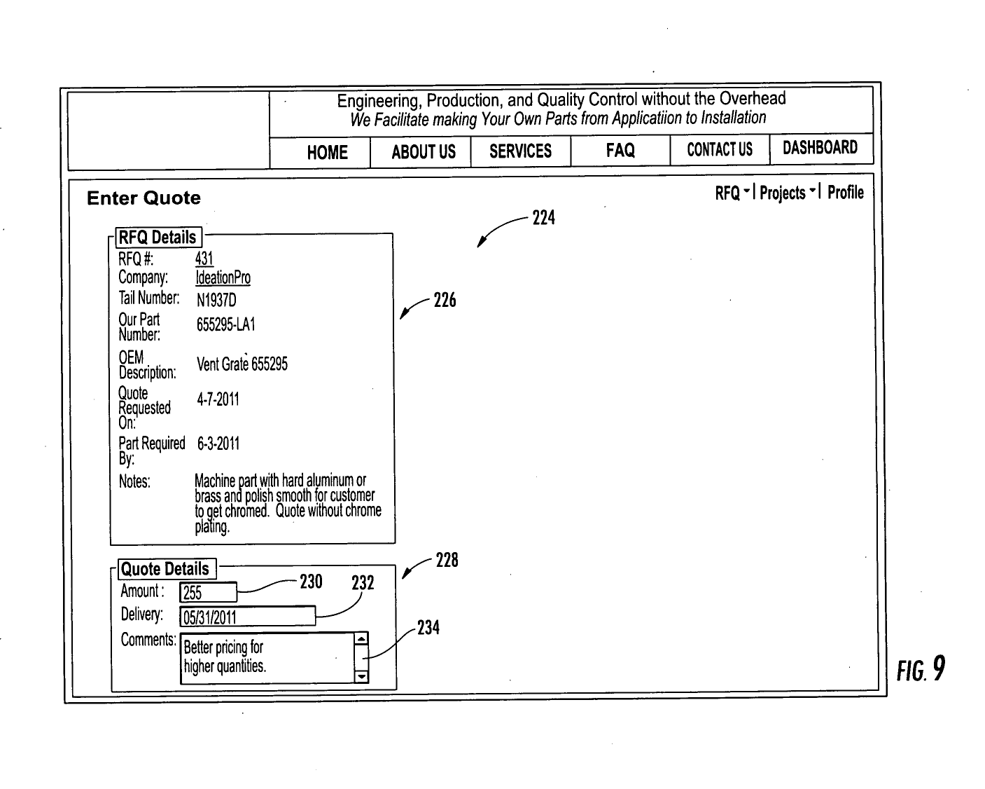

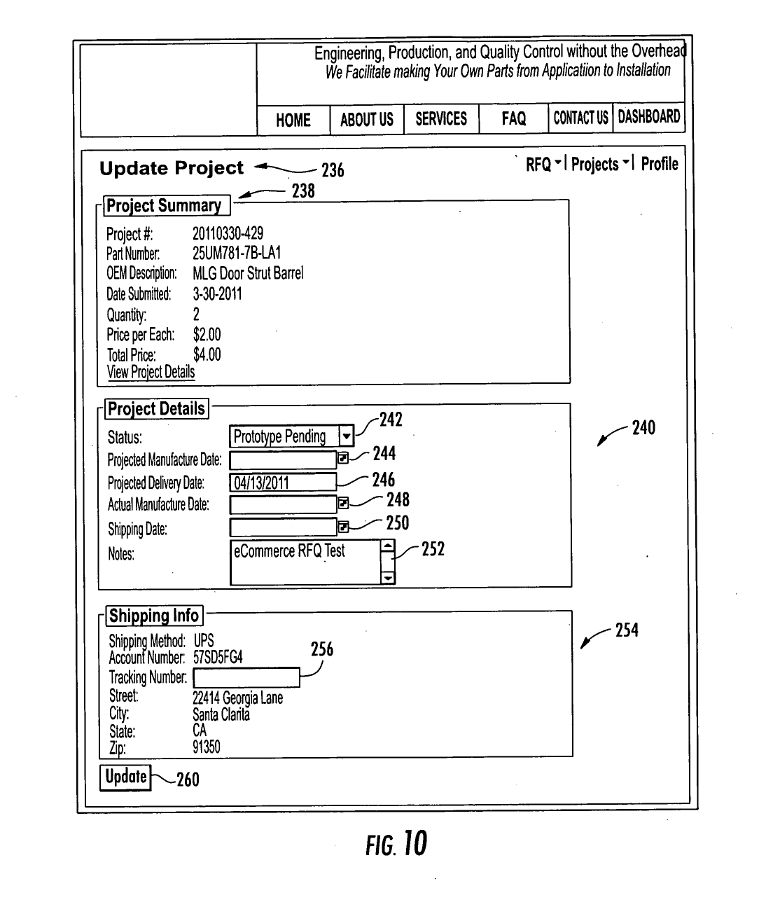

The system preferably provides a way for suppliers to post the order status on the website for the administrator or the user to see. FIGS. 9 and 10 show sample web pages for the suppliers to respond to the RFQs and to update order status. Web page 224 preferably provides suppliers with the details of the RFQ 226, which is based on the data entered by the users and reviewed by the administrator. The suppliers may respond to the RFQ by entering information on the quote details section 228. The suppliers may enter the amount to quote 230, the date the supplier can deliver 232, and comments for the administrator or the user 234. Web page 236 preferably serves as a tool for suppliers to communicate with the administrator or the user regarding the status of the order. A summary of the project 238 may be displayed as a reference tool. A project detail section 240 may allow the suppliers to indicate the status of the order 242. A variety of predefined status may be provided for the suppliers, such as “in queue,” “prototype pending,” “prototyping,” and the like. The suppliers may enter the projected manufacture date (244), projected delivery date (246), actual manufacture date (248), shipping date (250), and notes or comments for the administrator or users (252). The web page 236 preferably also includes a shipping information section 254, which may include information about the shipping method the supplier will use, the account number, and the delivery address. When the suppliers actually ship the part, they may obtain a shipping tracking number, which they may enter on the tracking number section 256 of the web page 236. It is noted that the suppliers may enter each information upon knowing or obtaining each of them. The web page 236 preferably includes an update icon 260 for the system to instantly post the suppliers' entry on the website for the administrator or the user to see. These updates can be viewed by the administrator or the user when they go to their respective dashboards. The user dashboard 96 is shown on FIG. 4 and explained above.

The administrator dashboard is shown on FIG. 3 wherein each of the RFQs listed 92 on the administrator dashboard 80 may be updated with the quotes received from the suppliers. For instance, RFQ number 431 has received three quotes from suppliers, which are $180, $255, and $285. RFQ number 426 has received only one quote, which is for $3. The administrator can use this dashboard to obtain updated quotes from suppliers and can navigate this dashboard to communicate with suppliers and users. When the part has been ordered, the RFQ data may also be added to the list of active projects 94 or manufacturing projects facilitated by the systems and methods of the present invention. The list of active projects 94 may include a project # column 262, name of client or user column 264, name of supplier column 266, column for the date the project was awarded or the date the quote was accepted by the user 268, column for the date the part is required by the user or administrator 270, column for the projected delivery date of the part 272, and order status column 274.

It can now be realized that certain embodiments of the present invention facilitate participation of aircraft owners or operators in controlling the design, manufacturing, and tracking the quality of the parts being produced, which in turn, saves the owners or operators from having to go through the PMA process to get aircraft parts for their own use. Certain embodiments of the present invention ask aircraft owners or operators to provide design or performance data, materials, fabrication processes or assembly methods, and quality control procedures. It can further be realized that certain embodiments memorialize the participation of the aircraft owners or operators in a very efficient and convenient manner and in a manner that can be easily retrieved in case of an FAA audit.

System Architecture

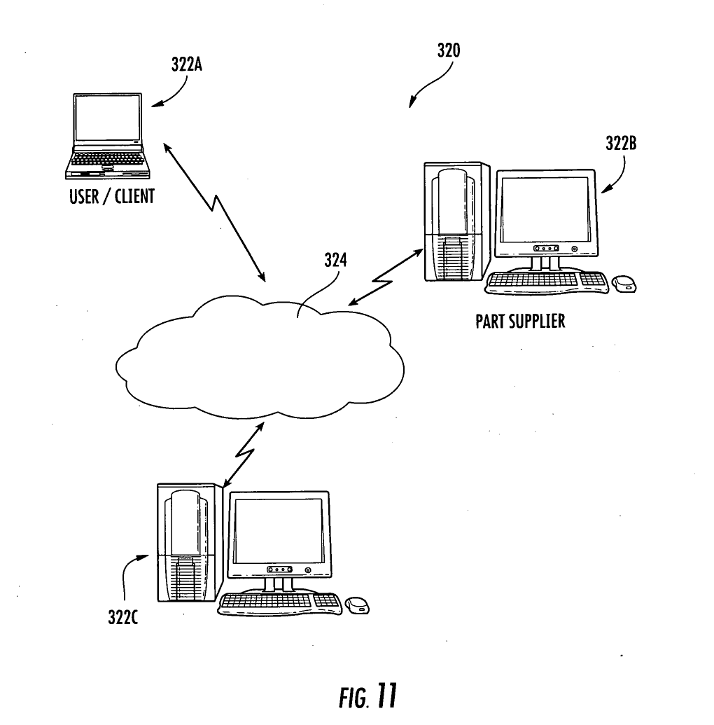

The various methods of the present invention may be implemented using an embodiment of a system shown in FIG. 11. The system preferably includes a plurality of computers 322a, 322b, and 322c connected to a network 324, such as the interne. User computer 322a may be configured for use by an individual or business aircraft owner, an aircraft operator, such as an airline or charter operator. Supplier computer 322b may be configured for use by a parts supplier who may be able to supply aircraft parts to the aircraft owner, the aircraft operator, or the service provider. Administrator computer 322c may be configured for use by an administrator or provider of certain embodiments of the present invention. The administrator computer 322c may sometimes be referred to as a supplier connector computer.

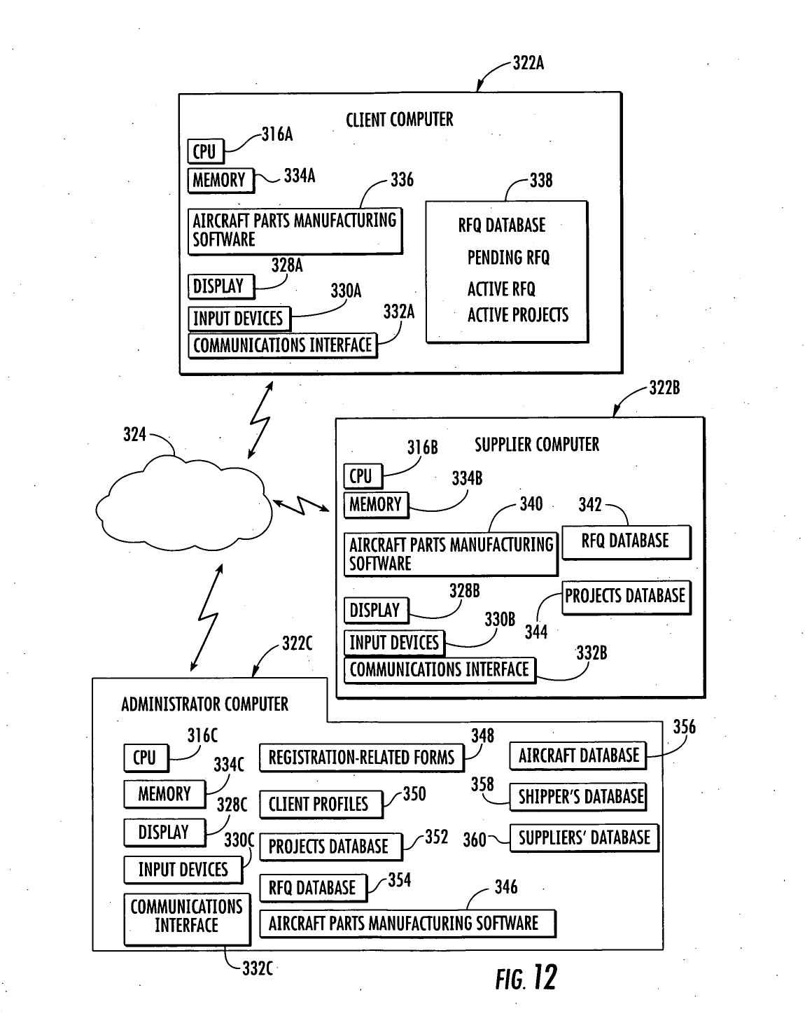

Referring now to FIG. 12, each computer 322a, 322b, and 322c preferably includes its respective: processor or CPU 316; display device 328, such as a monitor; input devices 330, such as a keyboard or a mouse; communications interface 332; and memory 334. The user computer 322a preferably includes a client version of an aircraft parts manufacturing software 336 that the user computer 322a can execute to implement certain embodiments of the present invention. The user computer 322a preferably also includes a database of a user's requests for quotations (RFQs) 338. The user's RFQs may be categorized into three categories-pending RFQs, active RFQs, or active projects. Pending RFQs may be incomplete or in-progress RFQs to be completed by the user and submitted to the administrator computer 322c. Active RFQs may be those RFQs that the user has previously submitted to the administrator computer 322c. Active projects may be those resulting from RFQs that have been submitted to the administrator computer 322c by the user, responded to by parts suppliers through supplier computers 322b, and accepted by the user.

The supplier computer 322b preferably includes a supplier version of the aircraft parts manufacturing software 340. The supplier computer 322b preferably stores a database of RFQs received by a supplier 342 and a projects database 344, which is preferably composed of RFQs accepted by clients and converted into actual manufacturing projects. The supplier computer 322b can preferably connect to a computer network 324, such as the interne, to connect with a user computer 322a and an administrator computer 322c. The administrator computer 322c preferably includes an administrator version of the aircraft parts manufacturing software 346. The aircraft parts manufacturing software 346 preferably includes an RFQ generator that transforms the aircraft part data entered by the user or the administrator into an RFQ. The aircraft parts manufacturing software 346 preferably further includes a part drawing uploader that is configured to allow a user to save a part drawing, which may be uses with the RFQ.

The administrator computer 322c preferably stores a plurality of databases, including: a database of registration-related forms 348, a database of client profiles 350, a database of projects facilitated through the system 352, a database of RFQs transmitted through the system 354, a database of Client's aircrafts 356, a database of shipping companies 358, and a database of parts suppliers or manufacturers 360. It is noted that the administrator computer 322c may include either an integrated or detached server computer that stores these plurality of databases.

It can now be realized that certain embodiments of the present invention serve as valuable resources in facilitating the bidding process between those in need of aircraft parts and the manufacturers. For instance, certain embodiments provide an efficient way of gathering from those in need of aircraft parts essential documents and information needed by manufacturers to take on a manufacturing project. Certain embodiments efficiently supplement deficient documents on behalf of those in need of aircraft parts. Yet, certain embodiments may provide a database of manufacturers and a system that facilitates the selection of the manufacturers to invite to bid on a manufacturing project. Certain embodiments may also allow the essential documents and information to be transmitted at once to multiple manufacturers. Certain embodiments may further create a central depository of essential documents and information accessible to multiple manufacturers.

Certain embodiments of the present invention further serve as valuable resources in ordering aircraft parts. For instance, certain embodiments may allow users to monitor the status of their parts order. Certain systems and methods of the present invention provide a network where users can submit requests for quotations anywhere and to multiple manufacturers at once. The network may allow for: convenient upload of information that may be needed to facilitate the bidding process as well as the parts ordering process, such as engineering or prototype drawings; quick transmission of information and in a paperless manner; and, completion of the manufacturing process by allowing user to accept the parts as owner produced and receive parts certification documents.

Although the description above contains many specifications, these should not be construed as limiting the scope of the invention but as merely providing illustrations of some of the presently preferred embodiments of this invention. For example, the order in which the steps are presented above is not limited to any particular order and does not necessarily imply that they have to be performed in the order presented. The invention is not limited in its application to the details of the construction and to the arrangement of the components set forth in the above description or as illustrated in the drawings.

The invention claimed is:

1. A computer-implemented method for facilitating manufacturing of aircraft parts, the method comprising:
a. gathering from a user, via a first computer, the user's aircraft information;
b. gathering, via the first computer, a specification for an aircraft part;
c. soliciting, via a second computer, at least one quotation from a supplier to supply the aircraft part; and
d. ordering the aircraft part based on the quotation from the supplier.

2. The method of claim 1, further comprising:
a. providing a computer web site;
b. accepting registration applications from potential users; and
c. setting a user qualification to order an aircraft part.

3. The method of claim 2, wherein the user qualification is that the user owns an aircraft.

4. The method of claim 2, wherein the user qualification is that the user operates an aircraft.

5. The method of claim 1, further comprising providing the user an electronic form to complete, the electronic form comprising a field for the user's aircraft information and a field for the specification for the aircraft part.

6. The method of claim 1, wherein the specification for the aircraft part comprises dimensions of the aircraft part.

7. The method of claim 1, wherein the specification for the aircraft part comprises a material used to manufacture the aircraft part.

8. The method of claim 1, wherein the specification for the aircraft part comprises a manufacturing process used to manufacture the aircraft part.

9. The method of claim 1, wherein the specification for the aircraft part comprises the aircraft part's weight.

10. The method of claim 1, wherein the specification for the aircraft part comprises at least one drawing of the aircraft part.

11. The method of claim 1, wherein the specification for the aircraft part comprises an instruction on how to mark the aircraft part.

12. The method of claim 1, further comprising providing an updated status of the order.

13. A computer-implemented method for facilitating manufacturing of aircraft parts, the method comprising:
a. gathering via a computer manufacturing specification for at least one aircraft part from an aircraft part user;
b. composing via the computer a request for a quotation based on the gathered specification;
c. transmitting via a second computer the request for a quotation to a plurality of aircraft parts suppliers;
d. gathering from the plurality of aircraft parts suppliers a plurality of quotations to manufacture the aircraft part; and
e. transmitting the plurality of quotations to the aircraft part user.

14. The method of claim 13, further comprising:
a. gathering from the aircraft part user an acceptance of a quotation from the plurality of quotations;
b. transmitting the acceptance to the aircraft parts supplier that provided the quotation; and
c. providing the aircraft part user with a status of the manufacturing of the aircraft part.

15. The method of claim 13, further comprising the step of qualifying the aircraft part user, the step of qualifying the aircraft part user comprising determining whether the aircraft part user is an aircraft owner.

16. The method of claim 13, further comprising the step of qualifying the aircraft part user, the step of qualifying the aircraft part user comprising determining whether the aircraft part user is an aircraft operator.

17. A system for facilitating manufacturing of aircraft aftermarket parts, the system comprising:
a. an aircraft part user computer, the aircraft part user computer comprising an input device, the input device being configured to allow a user to enter an aircraft part specification;
b. a server computer connected to the aircraft part user computer, the server computer comprising:
i) a request for quotation generator configured to generate a request for quotation based on the aircraft part specification entered by the user; and
ii) a database of a plurality of aircraft part suppliers; and
c. a supplier connector computer connected to the aircraft part user computer and the server computer, the supplier connector computer configured to utilize the database and transmit the request for a quotation to the plurality of aircraft part suppliers, the supplier connector computer further configured to receive quotations from the plurality of aircraft part suppliers and transmit the quotations to the aircraft part user computer.

18. The system of claim 18, further comprising an aircraft part drawing loader, the aircraft part drawing loader configured to allow the aircraft part user to save a drawing of an aircraft part.

19. The system of claim 18, wherein the supplier connector is configured to accept a part order, the aircraft part user computer further comprising a display device connected to the input device, the display device being configured to show a status of the part order.

20. The system of claim 18, wherein the server computer is configured to store a database of electronic forms, the database of electronic forms comprising a request for quotation form.
